(19) United States
(12) Patent Application Publication
(10) Pub. No.: US 2011/0244260 A1
(43) Pub. Date: Oct. 6, 2011

(54) Cu-Ni-Si-Co COPPER ALLOYS FOR ELECTRONIC MATERIALS AND MANUFACTURING METHODS THEREOF

(75) Inventor: Hiroshi Kuwagaki, Ibaraki (JP)

(73) Assignee: JX Nippon Mining & Metals Corporation, Tokyo (JP)

(21) Appl. No.: 13/131,718

(22) PCT Filed: Nov. 20, 2009
(86) PCT No.: PCT/JP2009/069715

§ 371 Date: Jun. 16, 2011

(30) Foreign Application Priority Data
Dec. 1, 2008 (JP) 2008-306266

(51) Int. Cl. C22C 9/00; B32B 5/16; C22F 1/08

(52) U.S. Cl. 428/546; 148/682

(57) ABSTRACT

Provided is a Cu—Ni—Si—Co based copper alloy with which high levels of strength and conductivity are achieved, and that also has excellent permanent fatigue resistance. The copper alloy for electronic materials contains Ni: 1.0-2.5 mass %, Co: 0.5-2.5 mass %, and Si: 0.3-12 mass %, and the remainder comprises Cu and unavoidable impurities. Of the second phase particles precipitated in the matrix, the number density of those having a particle diameter of 5-50 nm is 1×10¹² to 1×10¹⁴/mm³, and the number density of those having a particle diameter of 5 nm to less than 20 nm is 3-6 as represented by the ratio to the number density of those having a particle diameter of 20-50 nm.

### TECHNICAL FIELD

The present invention relates to a precipitation hardened copper alloy, in particular, the present invention relates to a Cu—Ni—Si—Co copper alloy suitable for use in various electronic parts.

### BACKGROUND ART

For copper alloys for electronic materials used in various electronic parts such as connectors, switches, relays, pins, terminals, lead frames etc., it is desired to satisfy both high strength and high electrical conductivity (or thermal conductivity) as basic properties. In recent years, high integration as well as reduction in size and thickness of electronic parts have rapidly advanced, and in correspondence, the desired level for copper alloys used in electronic device parts are becoming increasingly sophisticated.

In regards to high strength and high electrical conductivity, the amount of precipitation hardened copper alloy used as the copper alloy for electronic materials, in place of solid solution strengthened copper alloys such as conventional phosphor bronze and brass, have been increasing. In precipitation hardened copper alloys, microfine precipitates uniformly disperse by age-treating a solutionized supersaturated solid solution to increase alloy strength, and at the same time the amount of solutionized element in copper decrease to improve electrical conductivity. As a result, a material having mechanical characteristics such as strength and spring property as well as good electrical and thermal conductivity is obtained.

Among precipitation hardened copper alloys, a Cu—Ni—Si copper alloy generally referred to as the Corson alloy is a representative copper alloy that possesses the combination of relatively high electrical conductivity, strength, and bendability, making it one of the alloys that are currently under active development in the industry. In this copper alloy, improvement of strength and electrical conductivity is attempted by allowing microfine Ni—Si intermetallic compound particles to precipitate in the copper matrix.

In order to improve further properties of the Corson alloy, various technical developments such as addition of alloy components other than Ni and Si, exclusion of components that adversely affect property, optimization of crystalline organization, and optimization of precipitation particles have been performed. For example, properties are known to improve by adding Co or by controlling second phase particles precipitating in the matrix, and recent improvement technologies on Cu—Ni—Si—Co copper alloys are listed below.

Japanese Translation of PCT International Application Publication No. 2005-532477 (patent document 1) describes a wrought copper alloy consisting of, by weight, nickel: 1%-2.5%, cobalt: 0.5-2.0%, silicon: 0.5%-1.5%, and the remainder comprising copper and unavoidable impurities, wherein the total amount of nickel and cobalt contained is 1.7% to 4.3% with a ratio of (Ni+Co)/Si being between 2:1 and 7:1, wherein said wrought copper alloy have an electrical conductivity greater than 40% IACS. Cobalt is combined with silicon to form silicides that are effective for age hardening, to restrict grain growth and to increase softening resistance. The manufacturing step thereof includes the sequential steps of: without any intervening cold work following solutionizing, first age annealing the said alloy that is substantially a single phase at a first age annealing temperature and for a second time effective to precipitate a second phase to form a multiphase alloy having silicides; cold working the multiphase alloy to effect a second reduction in cross-sectional area; and second age annealing the multiphase alloy at a temperature (provided that the second age annealing temperature is lower than the first age annealing temperature) and for a time effective to increase the volume fraction of particles precipitated (paragraph 0018). It is also described that solutionizing is carried out at a temperature of 750° C. to 1050° C. for 10 seconds to 1 hour (paragraph 0042), first age annealing is carried out at a temperature of 350° C. to 600° C. for 30 minutes to 30 hours, cold work is carried out with a reduction ratio of 5-50%, and second age annealing temperature is 350° C. to 600° C. for 10 seconds to 30 hours (paragraphs 0045-0047).

Japanese Published Unexamined Patent Application Publication No. 2007-169765 (patent document 2) discloses that in a copper alloy having excellent strength, electrical conductivity, bendability, and stress relaxation property, characterized in that it contains Ni: 0.5-4.0% by mass, Co: 0.5-2.0% by mass, Si: 0.3-1.5% by mass, and the remainder comprising copper and unavoidable impurities, with the ratio of the sum of Ni amount and Co amount to Si amount (Ni+Co)/Si being 2 to 7, and the density (number per unit area) of second phase being 10⁸ to 10¹²/mm², the density of the second phase of a size of 50 to 1000 nm is 10⁴ to 10⁸/mm².

According to this patent document, superiority in various properties can be realized by setting the density (number per unit area) of the second phase to 10⁸ to 10¹²/mm² (paragraph 0019). In addition, by setting the density of the second phase having a size of 50-1000 nm to 10⁴-10⁸/mm², and by dispersing the second phase, bendability can be improved by controlling the coarsening of crystal grain size during solutionizing thermal treatments at high temperatures such as 850° C. or above (paragraph 0022). On the other hand, when the size of the second phase is less than 50 nm, the effect of controlling grain growth is small and is thus not preferred (paragraph 0023).

It is described that the above copper alloy can be manufactured by uniform thermal treatment of ingots at 900° C. or above, cooling to 850° C. at a speed of 0.5-4° C./second in the subsequent hot working, and then carrying out once or more each of thermal treatment and cold working (paragraph 0029).
Patent Document 1: Japanese Translation of PCT International Application Publication No. 2005-532477
Patent Document 2: Japanese Published Unexamined Patent Application Publication No. 2007-169765

### DISCLOSURE OF THE INVENTION

### Problems to be Solved by the Invention

The copper alloy described in patent document 1 can give relatively high strength, electrical conductivity and bendability, but there is still a margin for improvement in property. In particular, there was a problem that fatigue resistance, which is a permanent deformation produced when utilized as spring material, was insufficient. Patent document 2 discusses the effect of the distribution of second phase particles on alloy property and defines the distribution of second phase particles, but it is still not sufficient.

Since improvement of fatigue resistance will lead to improvement of reliability as spring material, it will be of advantage if fatigue resistance can also be improved. Thus, one subject of the present invention is to provide a Cu—Ni—Si—Co copper alloy that achieves high strength, electrical conductivity and bendability, as well as being having excellent fatigue resistance. In addition, another subject of the present invention is to provide a method for manufacturing such Cu—Ni—Si—Co alloy.

### Means for Solving the Problems

The present inventors have performed intensive research to solve the above problems, and found that in observing the structure of Cu—Ni—Si—Co alloy, the number density of extremely microfine second phase particles having a particle size of about 50 nm or less, the existence itself of which is undesirable according to patent document 2, has a significant effect on improvement of strength, electrical conductivity and fatigue resistance. Among them, since second phase particles having a particle size in the range of 5 nm to less than 20 nm contribute to improvement of strength and initial fatigue resistance, and second phase particles having a particle size in the range of 20-50 nm contribute to improvement of repeat fatigue resistance, it was found that strength and fatigue resistance can be improved in good balance by controlling the number density and the proportion thereof.

In one aspect, the present invention which was completed based on the above knowledge is a copper alloy for electronic materials containing Ni: 1.0-2.5% by mass, Co: 0.5-2.5% by mass, Si: 0.3-1.2% by mass, and the remainder comprising Cu and unavoidable impurities, wherein among the second phase particles that precipitated in the matrix, the number density of those having a particle size of 5-50 nm is 1×10¹² to 1×10¹⁴/mm³, and the number density of those having a particle size of 5 nm to less than 20 nm is 3-6 as represented by the ratio to the number density of those having a particle size of 20-50 nm.

In one embodiment of the copper alloy according to the present invention, the number density of second phase particles having a particle size of 5 nm to less than 20 nm is 2×10¹² to 7×10¹³, and the number density of second phase particles having a particle size of 20-50 nm is 3×10¹¹ to 2×10¹³.

In another embodiment of the copper alloy according to the present invention, it further contains up to 0.5% by mass of Cr.

In a further embodiment of the copper alloy according to the present invention, it further contains a total of up to 2.0% by mass of one or more selected from the group consisting of Mg, P, As, Sb, Be, B, Mn, Sn, Ti, Zr, Al, Fe, Zn and Ag.

In another aspect, the present invention is a method for manufacturing a copper alloy for electronic materials, comprising the sequential steps of:

step 1 of fusion casting an ingot having a desired composition;

step 2 of heating at a material temperature of 950-1050° C. for 1 hour or more, and then hot rolling;

optional step 3 of cold rolling;

step 4 of solutionizing by heating at a material temperature of 950-1050° C.;

step 5 of first aging treatment by heating at a material temperature of 400-500° C. for 1 to 12 hours;

step 6 of cold rolling with a thickness reduction of 30-50%; and

step 7 of second aging treatment by heating at a material temperature of 300-400° C. for 3 to 36 hours, wherein the heating time is 3 to 10-folds of the first aging treatment.

In a further aspect, the present invention is a wrought copper product made of the copper alloy according to the present invention.

In a further aspect, the present invention is electronic parts having the copper alloy according to the present invention.

### Advantages of the Invention

The present invention provides for a Cu—Ni—Si—Co copper alloy which is improved in balance of strength, electrical conductivity, bendability and fatigue resistance.

### BRIEF DESCRIPTION OF THE DRAWING

FIG. 1 is an illustration of the fatigue resistance test.

### BEST MODE FOR CARRYING OUT THE INVENTION

### Addition Amounts of Ni, Co and Si

Ni, Co and Si form an intermetallic compound by appropriate thermal treatment, and high strengthening can be attempted without deteriorating electrical conductivity.

Desired strength cannot be obtained if the addition amounts of Ni, Co and Si are Ni: less than 1.0% by mass, Co: less than 0.5% by mass, and Si: less than 0.3% by mass, respectively. On the other hand, with Ni: more than 2.5% by mass, Co: more than 2.5% by mass, and Si: more than 1.2% by mass, high strengthening can be attempted but electrical conductivity is significantly reduced, and further, hot working capability is deteriorated. The addition amounts of Ni, Co and Si are therefore set at Ni: 1.0-2.5% by mass, Co: 0.5-2.5% by mass, and Si: 0.3-1.2% by mass. The addition amounts of Ni, Co and Si are preferably Ni: 1.5-2.0% by mass, Co: 0.5-2.0% by mass, and Si: 0.5-1.0% by mass.

### Addition Amount of Cr

In the cooling process during fusion casting, Cr can strengthen crystal grain boundary because it preferentially precipitates at the grain boundary, allows for less generation of cracks during hot working, and can control the reduction of yield. In other words, Cr that underwent grain boundary precipitation during fusion casting will be resolutionized by for example solutionizing, but forms precipitation particles of bcc structure having Cr as the main component or a compound with Si during the subsequent aging precipitation. In an ordinary Cu—Ni—Si alloy, of the amount of Si added, Si that did not contribute to aging precipitation will control the increase in electrical conductivity while remaining solutionized in the matrix, but the amount of solutionized Si can be decreased by adding silicide-forming element Cr to further precipitate the silicide, and electrical conductivity can be increased without any loss in strength. However, when Cr concentration is more than 0.5% by mass, coarse second phase particles tend to form and product property is lost. Accordingly, up to 0.5% by mass of Cr can be added to the Cu—Ni—Si—Co alloy according to the present invention. However, since less than 0.03% by mass will only have a small effect, preferably 0.03-0.5% by mass, more preferably 0.09-0.3% by mass may be added.

### Addition Amounts of Mg, Mn, Ag and P

Mg, Mn, Ag and P will improve product properties such as strength and stress relaxation property without any loss of electrical conductivity with addition of just a trace amount. The effect of addition is mainly exerted by solutionizing into the matrix, but further effect can also be exerted by being contained in second phase particles. However, when the total concentration of Mg, Mn, Ag and P is more than 2.0% by mass, the effect of improving the property will saturate and in addition manufacturability will be lost. Accordingly, it is preferred to add a total of up to 2.0% by mass of one or two or more selected from Mg, Mn, Ag and P to the Cu—Ni—Si—Co alloy according to the present invention. However, since less than 0.01% by mass will only have a small effect, more preferably a total of 0.01-2.0% by mass, even more preferably a total of 0.02-0.5% by mass, typically a total of 0.04-0.2% by mass is added.

### Addition Amounts of Sn and Zn

Sn and Zn will also improve product properties such as strength, stress relaxation property, and platability without any loss of electrical conductivity with addition of just a trace amount. The effect of addition is mainly exerted by solutionizing into the matrix. However, when the total concentration of Sn and Zn is more than 2.0% by mass, the effect of improving the property will saturate and in addition manufacturability will be lost. Accordingly, a total of up to 2.0% by mass of one or two selected from Sn and Zn can be added to the Cu—Ni—Si—Co alloy according to the present invention. However, since less than 0.05% by mass will only have a small effect, preferably a total of 0.05-2.0% by mass, more preferably a total of 0.5-1.0% by mass may be added.

### Addition Amounts of As, Sb, Be, B, Ti, Zr, Al and Fe

As, Sb, Be, B, Ti, Zr, Al and Fe will also improve product properties such as electrical conductivity, strength, stress relaxation property, and platability by adjusting the addition amount according to the desired product property. The effect of addition is mainly exerted by solutionizing into the matrix, but further effect can also be exerted by being contained in second phase particles, or by forming second phase particles of new composition. However, when the total of these elements is more than 2.0% by mass, the effect of improving the property will saturate and in addition manufacturability will be lost. Accordingly, a total of up to 2.0% by mass of one or two or more selected from As, Sb, Be, B, Ti, Zr, Al and Fe can be added to the Cu—Ni—Si—Co alloy according to the present invention. However, since less than 0.001% by mass will only have a small effect, preferably a total of 0.001-2.0% by mass, more preferably a total of 0.05-1.0% by mass is added.

Since manufacturability is prone to be lost when the above-described addition amounts of Mg, P, As, Sb, Be, B, Mn, Sn, Ti, Zr, Al, Fe, Zn and Ag in total exceed 2.0% by mass, preferably the total of these is 2.0% by mass or less, more preferably 1.5% by mass or less, and even more preferably 1.0% by mass or less.

### Distribution Condition for Second Phase Particles

In the present invention, second phase particles refer mainly to silicides and include, but not limited to, crystallizations produced during solidification process of fusion casting and precipitates produced in the subsequent cooling process, precipitates produced in the cooling process following hot rolling, precipitates produced in the cooling process following solutionizing, as well as precipitates produced in the aging treatment process.

For a common Corson alloy, it is known that microfine second phase particles in the order of nanometers (generally less than 0.1 μm) consisting mainly of intermetallic compounds precipitate by appropriate aging treatment, and high strengthening can be attempted without deteriorating electrical conductivity. However, among microfine second phase particles, there are particle size range that are apt to contribute to strength and particle size range that are apt to contribute to fatigue resistance, and it has not been previously known that strength and fatigue resistance can be further improved with good balance by appropriately controlling these precipitation states.

The present inventors have found that the number density of extremely microfine second phase particles having a particle size of about 50 nm or less has a significant effect on improvement of strength, electrical conductivity and fatigue resistance. Among these, since second phase particles having a particle size in the range of 5 nm to less than 20 nm contribute to strength and initial fatigue resistance, and second phase particles having a particle size in the range of 20-50 nm contribute to improvement of repeat fatigue resistance, it was found that strength and fatigue resistance can be improved in good balance by controlling the number density and the proportion thereof.

Specifically, first, it is important to control the number density of second phase particles having a particle size of 5-50 nm to 1×10¹² to 1×10¹⁴/mm³, preferably 5×10¹² to 5×10¹³/mm³. If the number density of said second phase particles is less than 1×10¹²/mm, almost no advantage from precipitation strengthening can be obtained and therefore desired strength and electrical conductivity cannot be obtained, and fatigue resistance will also be poor. On the other hand, although it is thought that higher the number density of said second phase particles within feasible levels, the more improved the properties become, if precipitation of second phase particles are promoted to increase the number density, coarsening of second phase particles tend to occur, and it is therefore difficult to generate a number density of greater than 1×10¹⁴/mm³.

In addition, in order to improve strength and fatigue resistance in good balance, it is necessary to control the ratio between the number density of second phase particles having a particle size of 5 nm to less than 20 nm that are apt to contribute to strength improvement and the number density of second phase particles having a particle size of 20-50 nm that are apt to contribute to fatigue resistance improvement. Specifically, the number density of second phase particles having a particle size of 5 nm to less than 20 nm is controlled to 3-6 as represented by the ratio to the number density of second phase particles having a particle size of 20-50 nm. If said ratio is less than 3, the ratio of second phase particles that contribute to strength will become too small and the balance between strength and fatigue resistance will become poor, and thus strength is reduced and further initial fatigue resistance will also become poor. On the other hand, if said ratio is greater than 6, the ratio of second phase particles that contribute to fatigue resistance will become too small and the balance between strength and fatigue resistance will again become poor, and in this case repeat fatigue resistance will become poor.

In one preferred embodiment, the number density of second phase particles having a particle size of 5 nm to less than 20 nm is 2×10¹² to 7×10¹³/mm³, and the number density of second phase particles having a particle size of 20-50 nm is 3×10¹¹ to 2×10¹³/mm³.

In addition, strength will also depend on the number density of second phase particles having a particle size greater than 50 nm, but by controlling the number density of second phase particles having a particle size of 5-50 nm as described above, the number density of second phase particles having a particle size greater than 50 nm will naturally settle within an appropriate range.

In one preferred embodiment, when Badway W bend test is performed following JIS H 3130, the copper alloy according to the present invention will have a MBR/t value of 2.0 or less, i.e., the ratio of minimum radius without occurrence of cracking (MBR) to plate (t). MBR/t value can typically be in a range of 1.0 to 2.0.

### Manufacturing Method

In a general manufacturing process for the Corson copper alloy, first, using an atmosphere furnace, materials such as electrolytic copper, Ni, Si, and Co are fused to obtain molten metal of desired composition. Then, this molten metal is casted into ingots. Subsequently, hot rolling is carried out, and cold rolling and thermal treatment are repeated to finish the products into strips and foils having the desired thickness and properties. Thermal treatment includes solutionizing and aging treatment. Solutionizing is carried out by heating at a high temperature of about 700 to about 1000° C., solutionizing the second phase particles into the Cu matrix, and simultaneously recrystallizing the Cu matrix. Solutionizing is also sometimes performed as hot rolling. Aging treatment is carried out by heating at a temperature range of about 350 to about 550° C. for 1 hour or more, and precipitating the second phase particles that were solutionized in the solutionizing step as microfine particles in the order of nanometers. This aging treatment increases strength and electrical conductivity. Cold rolling may be performed before and/or after aging in order to obtain higher strength. In addition, when cold rolling after aging, annealing to remove deformation (low temperature annealing) may be performed following cold rolling.

In between each of the above steps, grinding, polishing, shotblast acid washing etc. are suitably performed to remove oxidation scales on the surface as appropriate.

The above manufacturing process is basically carried out for the copper alloy according to the present invention as well, but in order to have the distribution format of second phase particles in the range defined by the present invention in the copper alloy ultimately obtained, it is important to strictly control hot rolling, solutionizing and aging treatment conditions. This is because in contrast to the conventional Cu—Ni—Si Corson alloy, Co (as well as Cr in some cases) which makes second phase particles liable to coarsening are willingly added to the Cu—Ni—Co—Si alloy of the present invention as an essential component for aging precipitation hardening. This is due to the fact that the production and growth speed of second phase particles formed from the added Co together with Ni or Si are sensitive to the holding temperature and cooling speed upon thermal treatment.

First, since coarse crystallizations are inevitably produced in the solidification process during casting, and coarse precipitates are inevitably produced in its cooling process, these second phase particles need to be solutionized into the matrix in the subsequent step. If hot rolling is performed after holding at 950° C. to 1050° C. for 1 hour or more, and the temperature at completion of hot rolling is set at 850° C. or above, Co as well as Cr can be added and still be solutionized into the matrix. A temperature condition of 950° C. or above is a higher temperature setting compared to other Corson alloys. Solutionizing will be insufficient if the holding temperature before hot rolling is below 950° C., and material may melt if it exceeds 1050° C. In addition, if the temperature at completion of hot rolling is below 850° C., solutionized element will reprecipitate and it will become difficult to obtain high strength. Accordingly, in order to obtain high strength, it is desirable to complete hot rolling at 850° C. and subject it to rapid cooling. Rapid cooling can be achieved by water cooling.

The aim for solutionizing is to enhance age hardening capability after solutionizing by solutionizing crystallized particles during fusion casting or precipitation particles after hot rolling. The heating temperature and time during solutionizing will be important when controlling the number density of second phase particles. If the holding time is constant, solutionizing of crystallized particles during fusion casting or precipitation particles after hot rolling will be possible by raising the heating temperature, and it will be possible to decrease the area ratio. Specifically, solutionizing will be insufficient if the solutionizing temperature is below 950° C. and desired strength cannot be obtained, whereas materials may fuse if the solutionizing temperature is above 1050° C. Accordingly, it is preferred to solutionize by heating at a material temperature of 950-1050° C. Solutionizing time is preferably 60 seconds to 1 hour. The cooling speed following solutionizing is preferably rapid cooling to prevent precipitation of solutionized second phase particles.

In manufacturing the Cu—Ni—Co—Si alloy according to the present invention, it is effective to perform mild aging treatment in two stages following solutionizing, with cold rolling in between the two aging treatments. In this way, coarsening of precipitates is controlled, and distribution of second phase particles as defined in the present invention can be obtained.

First, in the first aging treatment, a temperature slightly lower than the condition commonly used as being useful for microfining the precipitates is selected, and precipitation of the microfine second phase particles is promoted while preventing coarsening of precipitates that may have precipitated during second solutionizing. If the first aging treatment is below 400° C., the density of second phase particles having a size of 20 nm to 50 nm which improve repeat fatigue resistance tend to be lower, whereas if the first aging is above 500° C. the condition will be over-aging, and the density of second phase particles having a size of 5 nm to 20 nm which contribute to strength and initial fatigue resistance tend to be lower. Accordingly, first aging treatment is preferably in a temperature range of 400-500° C. for 1 to 12 hours, more preferably a temperature range of 450-480° C. for 3 to 9 hours.

Cold rolling is carried out after first aging treatment. In this cold rolling, insufficient age hardening in the first aging treatment can be compensated by work hardening. If the thickness reduction for this is 30% or less, distortion that will be a site for precipitation will decrease, and precipitation of second phase particles during second aging will tend to be ununiform. Thickness reduction of 50% or more in cold rolling will tend to produce bad bendability. In addition, second phase particles that precipitated in the first aging will resolutionize. Accordingly, thickness reduction of cold rolling after first aging treatment is preferably 30-50%, more preferably 35-40%.

The aim for second aging treatment is to precipitate second phase particles finer than the second phase particles precipitated in the first aging treatment, while preventing as much as possible the growth of second phase particles precipitated in the first aging treatment. If the second aging temperature is set too high, second phase particles already precipitated will overgrow, and distribution of the number density of second phase particles intended by the present invention will not be obtained. It is thus be noted that the second aging treatment should be carried out at a low temperature. However, new second phase particles will not precipitate if the second aging treatment temperature is too low. Accordingly, the second aging treatment is preferably at a temperature range of 300-400° C. for 3 to 36 hours, more preferably at a temperature range of 300-350° C. for 9 to 30 hours.

In controlling the number density of second phase particles having a particle size of 5 nm to less than 20 nm to 3-6 as represented by the ratio to the number density of second phase particles having a particle size of 20-50 nm, the relationship between the second and first age treatment time will also be important. Specifically, by setting the second aging treatment time to 3-folds or longer than the first aging treatment time, second phase particles having a particle size of 5 nm to less than 20 nm that precipitate will be relatively greater, allowing the ratio of the above number density to be 3 or more. If the second aging treatment time is less than 3-folds of the first aging treatment time, second phase particles having a particle size of 5 nm to less than 20 nm will be relatively less, and the ratio of the above number density tends to be less than 3.

However, if the second aging treatment time is dramatically longer (e.g., 10-folds or more) than the first aging treatment time, although second phase particles having a particle size of 5 nm to less than 20 nm will increase, second phase particles having a particle size of 20-50 nm will also increase due to growth of precipitates that precipitated in the first aging treatment and growth of precipitates that precipitated in the second aging treatment, and the ratio of the above number density will again tend to be less than 3.

Accordingly, the second aging treatment time is preferably 3 to 10-folds, more preferably 3 to 5-folds of the first aging treatment time.

The Cu—Ni—Si—Co alloy of the present invention can be processed into various wrought copper and copper alloy products, for example boards, strips, tubes, bars and wires, and further, the Cu—Ni—Si—Co copper alloy according to the present invention can be used in electronic parts such as lead frames, connectors, pins, terminals, relays, switches, and foil for secondary battery, and particularly suitable for use as spring material.

### EXAMPLES

Examples of the present invention will be shown below together with Comparative Examples. However, these Examples are provided to better understand the present invention and its advantages, and do not intend to limit the invention.

### 1. Examples of the Present Invention

Copper alloys having each of the component compositions listed in Table 1 were melted at 1300° C. with a high frequency fusion furnace, and casted into ingots having a thickness of 30 mm. Next, these ingots were heated at 1000° C. for 3 hours, after which the finishing temperature (temperature at completion of hot rolling) was set to 900° C. and hot rolled to 10 mm plates, and rapidly cooled with water to room temperature after completion of hot rolling. Next, scales on the surface were removed by facing to a thickness of 9 mm, and cold rolling was carried out to obtain plates having a thickness of 0.15 mm. Solutionizing was then carried out at respective temperature and time, and after completion of solutionizing, rapidly cooled with water to room temperature. Next, in an inert atmosphere, first aging treatment was carried out at respective temperature and time, subjected to cold rolling with respective thickness reduction, and finally, in an inert atmosphere, second aging treatment was carried out at respective temperature and time to manufacture each test strip.

TABLE 1

| | | | | | | | | | | Cold | | |
|---|---|---|---|---|---|---|---|---|---|---|---|---|
| | | | | | | | | | | Rolling | | |
| | | | | | | Solutionizing | | First Aging | | Thickness | Second Aging | |
| | Composition (% by mass) | | | | | Temperature | Time | Temperature | Time | Reduction | Temperature | Time |
| No. | Ni | Co | Si | Cr | Other | (° C.) | (s) | (° C.) | (hr) | (%) | (° C.) | (hr) |
| 1 | 1.8 | 1.0 | 0.65 | | | 1000 | 60 | 480 | 3 | 40 | 350 | 9 |
| 2 | 1.8 | 1.0 | 0.65 | | | 1000 | 60 | 480 | 3 | 40 | 325 | 15 |
| 3 | 1.8 | 1.0 | 0.65 | | | 1000 | 60 | 480 | 3 | 40 | 300 | 30 |
| 4 | 1.8 | 1.0 | 0.65 | | | 1000 | 60 | 480 | 3 | 30 | 325 | 15 |
| 5 | 1.8 | 1.0 | 0.65 | | | 1000 | 60 | 480 | 3 | 50 | 300 | 30 |
| 6 | 1.8 | 1.0 | 0.65 | | | 1000 | 60 | 450 | 9 | 40 | 300 | 30 |
| 7 | 1.8 | 1.0 | 0.65 | | | 1000 | 60 | 450 | 9 | 40 | 300 | 30 |
| 8 | 1.8 | 1.0 | 0.65 | | | 1000 | 60 | 450 | 9 | 30 | 300 | 30 |
| 9 | 1.8 | 1.0 | 0.65 | 0.2 | | 1000 | 60 | 480 | 3 | 40 | 350 | 9 |
| 10 | 1.8 | 1.0 | 0.65 | 0.2 | | 1000 | 60 | 480 | 3 | 40 | 325 | 15 |
| 11 | 1.8 | 1.0 | 0.65 | 0.2 | | 1000 | 60 | 480 | 3 | 40 | 300 | 30 |
| 12 | 1.8 | 1.0 | 0.65 | 0.2 | | 1000 | 60 | 480 | 3 | 30 | 325 | 15 |
| 13 | 1.8 | 1.0 | 0.65 | 0.2 | | 1000 | 60 | 480 | 3 | 50 | 300 | 30 |
| 14 | 1.8 | 1.0 | 0.65 | 0.2 | | 1000 | 60 | 450 | 9 | 40 | 300 | 30 |
| 15 | 1.8 | 1.0 | 0.65 | 0.2 | | 1000 | 60 | 450 | 9 | 40 | 300 | 30 |
| 16 | 1.8 | 1.0 | 0.65 | 0.2 | | 1000 | 60 | 450 | 9 | 30 | 300 | 30 |
| 17 | 1.8 | 0.6 | 0.54 | | | 950 | 60 | 480 | 3 | 40 | 350 | 9 |
| 18 | 1.8 | 0.6 | 0.54 | | | 950 | 60 | 480 | 3 | 40 | 325 | 15 |
| 19 | 1.8 | 0.6 | 0.54 | | | 950 | 60 | 480 | 3 | 40 | 300 | 30 |
| 20 | 1.8 | 0.6 | 0.54 | | | 950 | 60 | 450 | 9 | 40 | 300 | 30 |
| 21 | 1.8 | 0.6 | 0.54 | | | 950 | 60 | 450 | 9 | 40 | 300 | 30 |
| 22 | 1.8 | 0.6 | 0.54 | 0.2 | | 950 | 60 | 480 | 3 | 40 | 350 | 9 |
| 23 | 1.8 | 0.6 | 0.54 | 0.2 | | 950 | 60 | 480 | 3 | 40 | 325 | 15 |
| 24 | 1.8 | 0.6 | 0.54 | 0.2 | | 950 | 60 | 480 | 3 | 40 | 300 | 30 |
| 25 | 1.8 | 0.6 | 0.54 | 0.2 | | 950 | 60 | 450 | 9 | 40 | 300 | 30 |
| 26 | 1.8 | 0.6 | 0.54 | 0.2 | | 950 | 60 | 450 | 9 | 40 | 30 | 30 |
| 27 | 1.8 | 1.5 | 0.81 | | | 1020 | 60 | 480 | 3 | 40 | 350 | 9 |
| 28 | 1.8 | 1.5 | 0.81 | | | 1020 | 60 | 480 | 3 | 40 | 325 | 15 |
| 29 | 1.8 | 1.5 | 0.81 | | | 1020 | 60 | 480 | 3 | 40 | 300 | 30 |
| 30 | 1.8 | 1.5 | 0.81 | | | 1020 | 60 | 450 | 9 | 40 | 300 | 30 |
| 31 | 1.8 | 1.5 | 0.81 | | | 1020 | 60 | 450 | 9 | 40 | 300 | 30 |
| 32 | 1.8 | 1.5 | 0.81 | 0.2 | | 1020 | 60 | 480 | 3 | 40 | 350 | 9 |
| 33 | 1.8 | 1.5 | 0.81 | 0.2 | | 1020 | 60 | 480 | 3 | 40 | 325 | 15 |
| 34 | 1.8 | 1.5 | 0.81 | 0.2 | | 1020 | 60 | 480 | 3 | 40 | 300 | 30 |
| 35 | 1.8 | 1.5 | 0.81 | 0.2 | | 1020 | 60 | 450 | 9 | 40 | 300 | 30 |
| 36 | 1.8 | 1.5 | 0.81 | 0.2 | | 1020 | 60 | 450 | 9 | 40 | 300 | 30 |
| 37 | 1.5 | 1.0 | 0.6 | | | 970 | 60 | 480 | 3 | 40 | 325 | 15 |
| 38 | 1.5 | 1.0 | 0.6 | 0.2 | | 970 | 60 | 480 | 3 | 40 | 325 | 15 |
| 39 | 2 | 1.0 | 0.75 | | | 1020 | 60 | 480 | 3 | 40 | 325 | 15 |
| 40 | 2 | 1.0 | 0.75 | 0.2 | | 1020 | 60 | 480 | 3 | 40 | 325 | 15 |
| 41 | 1.8 | 1.0 | 0.65 | | 0.1 Mg | 1000 | 60 | 480 | 3 | 40 | 325 | 15 |
| 42 | 1.8 | 1.0 | 0.65 | 0.2 | 0.1 Mg | 1000 | 60 | 480 | 3 | 40 | 325 | 15 |
| 43 | 1.8 | 1.0 | 0.65 | | 0.5 Sn | 1000 | 60 | 480 | 3 | 40 | 325 | 15 |
| 44 | 1.8 | 1.0 | 0.65 | | 0.5 Zn | 1000 | 60 | 480 | 3 | 40 | 325 | 15 |
| 45 | 1.8 | 1.0 | 0.65 | | 0.1 Ag | 1000 | 60 | 480 | 3 | 40 | 325 | 15 |
| 46 | 1.8 | 1.0 | 0.65 | 0.2 | 0.5 Sn | 1000 | 60 | 480 | 3 | 40 | 325 | 15 |
| 47 | 1.8 | 1.0 | 0.65 | 0.2 | 0.5 Zn | 1000 | 60 | 480 | 3 | 40 | 325 | 15 |
| 48 | 1.8 | 1.0 | 0.65 | 0.2 | 0.1 Ag | 1000 | 60 | 480 | 3 | 40 | 325 | 15 |
| 49 | 1.8 | 1.0 | 0.65 | 0.2 | 0.005 B | 1000 | 60 | 480 | 3 | 40 | 325 | 15 |
| 50 | 1.8 | 1.0 | 0.65 | 0.2 | 0.03 Ti + | 1000 | 60 | 480 | 3 | 40 | 325 | 15 |
| | | | | | 0.03 Fe | | | | | | | |

For each test strip obtained as described, the number density of second phase particles and alloy properties were measured as follows.

Each test strip was polished to thin film to a thickness of about 0.1-0.2 μm, any 5-field observation (incidence direction is arbitrary) of 100,000× photograph using transmission electron microscope (HITACHI-H-9000) was performed, and the particle size of each second phase particle was measured on the photograph. The particle size of a second phase particle was defined as (long axis+lateral diameter)/2. The long axis refers to the length of the longest of the line segments that go through the center of mass of the particle and have the endpoints on the intersection with the borderline of particle, and the lateral diameter refers to the length of the shortest of the line segments that go though the center of mass of the particle and have the endpoints on the intersection with the borderline of particle. After measuring the particle size, the number of each particle size range is converted into the number per unit volume to determine the number density of each particle size range.

For strength, tensile test in the direction parallel to rolling was performed to measure 0.2% yield strength (YS: MPa).

Electrical conductivity (EC; % IACS) was determined by volume resistivity measurement by double bridge.

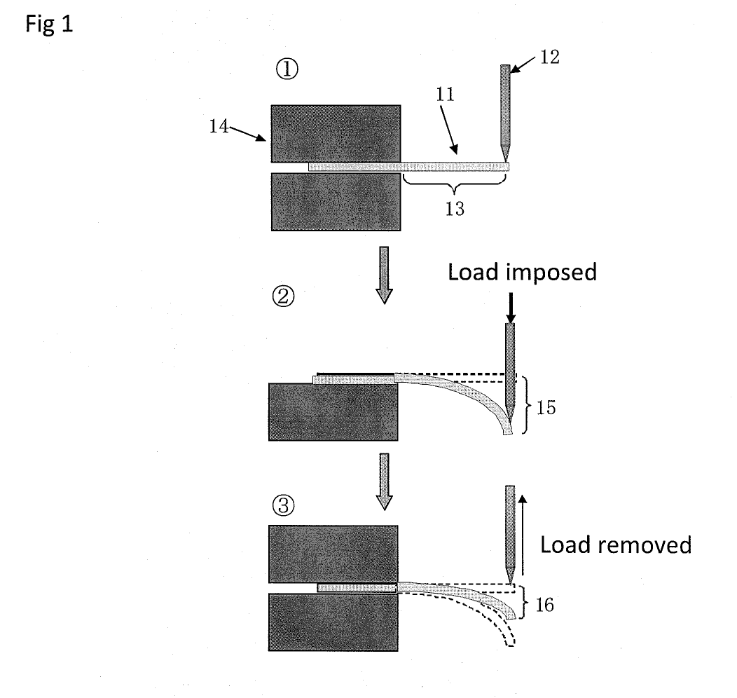

Fatigue resistance was measured as follows: as shown in FIG. 1, each test strip processed to width 1 mm×length 100 mm×thickness 0.08 mm was held between a vise, bending stress of gauge length=5 mm for stroke=1 mm was loaded with a knife edge at room temperature for 5 seconds, and the amount of permanent deformation (fatigue) is shown in Table 2. Initial fatigue resistance was assessed where the number of loads by knife edge is one, and repeat fatigue resistance was where the number of loads by knife edge is ten.

For bendability, Badway (bending axis is the same direction as the rolling direction) double bend test was performed following JIS H 3130 to measure the MBR/t value, i.e., the ratio of minimum radius without occurrence of cracking (MBR) to plate (t). In general, MBR/t can be assessed as follows:

| | |
|---|---|
| MBR/t ≦ 1.0 | Extremely superior |
| 1.0 < MBR/t ≦ 2.0 | Superior |
| 2.0 < MBR/t | Insufficient |

Measurement result for each test strip is shown in Table 2.

TABLE 2

| | Density of Precipitate (a = particle size; nm) | | | | | Electrical | Initial | Repeat | |
|---|---|---|---|---|---|---|---|---|---|
| | 5 ≦ a ≦ 50 | 5 ≦ a < 20 | 20 ≦ a ≦ 50 | Precipitate | Strength | Conductivity | Fatigue | Fatigue | |
| No. | (×10¹¹/mm³) | (×10¹¹/mm³) | (×10¹¹/mm³) | Ratio | YS (MPa) | EC (% IACS) | (mm) | (mm) | Bendability |
| 1 | 160.0 | 124.4 | 35.6 | 3.5 | 850 | 48 | 0 | 0.02 | 1.5 |
| 2 | 80.0 | 65.5 | 14.5 | 4.5 | 860 | 45 | 0.01 | 0.05 | 1.5 |
| 3 | 40.0 | 33.8 | 6.2 | 5.5 | 855 | 43 | 0.04 | 0.09 | 1.5 |
| 4 | 40.0 | 32.0 | 8.0 | 4 | 850 | 44 | 0.03 | 0.07 | 1.0 |
| 5 | 40.0 | 33.3 | 6.7 | 5 | 865 | 44 | 0.03 | 0.08 | 2.0 |
| 6 | 120.0 | 96.0 | 24.0 | 4 | 860 | 46 | 0.01 | 0.04 | 1.5 |
| 7 | 40.0 | 33.3 | 6.7 | 5 | 850 | 43 | 0.03 | 0.08 | 1.5 |
| 8 | 40.0 | 32.0 | 8.0 | 4 | 845 | 43 | 0.03 | 0.07 | 1.0 |
| 9 | 160.0 | 124.4 | 35.6 | 3.5 | 860 | 48 | 0 | 0.02 | 1.5 |
| 10 | 80.0 | 65.5 | 14.5 | 4.5 | 870 | 46 | 0.01 | 0.05 | 1.5 |
| 11 | 40.0 | 33.8 | 6.2 | 5.5 | 865 | 44 | 0.04 | 0.09 | 1.5 |
| 12 | 40.0 | 32.0 | 8.0 | 4 | 860 | 45 | 0.04 | 0.08 | 1.0 |
| 13 | 40.0 | 33.3 | 6.7 | 5 | 875 | 45 | 0.03 | 0.08 | 2.0 |
| 14 | 120.0 | 96.0 | 24.0 | 4 | 870 | 47 | 0 | 0.04 | 1.5 |
| 15 | 40.0 | 33.3 | 6.7 | 5 | 860 | 44 | 0.03 | 0.08 | 1.5 |
| 16 | 40.0 | 32.0 | 8.0 | 4 | 855 | 44 | 0.03 | 0.07 | 1.0 |
| 17 | 40.0 | 31.1 | 8.9 | 3.5 | 835 | 49 | 0 | 0.02 | 1.2 |
| 18 | 32.0 | 26.2 | 5.8 | 4.5 | 845 | 46 | 0.02 | 0.06 | 1.5 |
| 19 | 24.0 | 20.3 | 3.7 | 5.5 | 840 | 44 | 0.04 | 0.09 | 1.5 |
| 20 | 36.0 | 28.8 | 7.2 | 4 | 835 | 46 | 0 | 0.04 | 1.2 |
| 21 | 32.0 | 26.7 | 5.3 | 5 | 850 | 44 | 0.02 | 0.07 | 1.5 |
| 22 | 40.0 | 31.1 | 8.9 | 3.5 | 845 | 48 | 0 | 0.02 | 1.5 |
| 23 | 32.0 | 26.2 | 5.8 | 4.5 | 835 | 47 | 0.02 | 0.06 | 1.2 |
| 24 | 24.0 | 20.3 | 3.7 | 5.5 | 840 | 45 | 0.03 | 0.08 | 1.5 |
| 25 | 36.0 | 28.8 | 7.2 | 4 | 865 | 46 | 0.01 | 0.04 | 1.5 |
| 26 | 32.0 | 26.7 | 5.3 | 5 | 865 | 45 | 0.02 | 0.07 | 1.5 |
| 27 | 800.0 | 622.2 | 117.8 | 3.5 | 900 | 44 | 0 | 0.01 | 2.0 |
| 28 | 400.0 | 327.3 | 72.7 | 4.5 | 910 | 43 | 0 | 0.03 | 2.0 |
| 29 | 360.0 | 304.6 | 55.4 | 5.5 | 905 | 42 | 0.01 | 0.06 | 2.0 |
| 30 | 400.0 | 320.0 | 80.0 | 4 | 910 | 43 | 0 | 0.02 | 2.0 |
| 31 | 400.0 | 333.3 | 66.7 | 5 | 900 | 42 | 0 | 0.04 | 2.0 |
| 32 | 800.0 | 622.2 | 177.8 | 3.5 | 910 | 45 | 0 | 0.01 | 2.0 |
| 33 | 400.0 | 327.3 | 72.7 | 4.5 | 920 | 43 | 0 | 0.03 | 2.0 |
| 34 | 360.0 | 304.6 | 55.4 | 5.5 | 915 | 43 | 0.01 | 0.06 | 2.0 |
| 35 | 400.0 | 320.0 | 80.0 | 4 | 920 | 44 | 0 | 0.02 | 2.0 |
| 36 | 400.0 | 333.3 | 66.7 | 5 | 910 | 43 | 0 | 0.04 | 2.0 |
| 37 | 80.0 | 65.5 | 14.5 | 4.5 | 850 | 46 | 0.01 | 0.05 | 1.5 |
| 38 | 80.0 | 64.0 | 16.0 | 4 | 860 | 47 | 0.01 | 0.04 | 1.5 |
| 39 | 120.0 | 98.2 | 21.8 | 4.5 | 875 | 44 | 0 | 0.04 | 1.5 |
| 40 | 120.0 | 98.2 | 21.8 | 4.5 | 885 | 45 | 0.01 | 0.05 | 2.0 |
| 41 | 160.0 | 124.4 | 35.6 | 3.5 | 880 | 45 | 0 | 0.02 | 1.5 |
| 42 | 160.0 | 124.4 | 35.6 | 3.5 | 900 | 43 | 0 | 0.01 | 2.0 |
| 43 | 80.0 | 65.5 | 14.5 | 4.5 | 860 | 44 | 0 | 0.04 | 1.5 |
| 44 | 80.0 | 65.5 | 14.5 | 4.5 | 860 | 43 | 0 | 0.04 | 1.5 |
| 45 | 120.0 | 96.0 | 24.0 | 4 | 850 | 46 | 0.01 | 0.04 | 1.5 |
| 46 | 80.0 | 64.0 | 16.0 | 4 | 870 | 45 | 0 | 0.03 | 1.5 |
| 47 | 80.0 | 65.5 | 14.5 | 4.5 | 870 | 44 | 0.01 | 0.05 | 1.5 |
| 48 | 120.0 | 96.0 | 24.0 | 4 | 860 | 47 | 0 | 0.04 | 1.5 |
| 49 | 80.0 | 65.5 | 14.5 | 4.5 | 860 | 42 | 0.01 | 0.05 | 1.5 |
| 50 | 80.0 | 64.0 | 16.0 | 4 | 870 | 43 | 0 | 0.04 | 1.5 |

### 2. Comparative Examples

Copper alloys having each of the component compositions listed in Table 3 were melted at 1300° C. with a high frequency fusion furnace, and casted into ingots having a thickness of 30 mm. Next, these ingots were heated at 1000° C. for 3 hours, after which the finishing temperature (temperature at completion of hot rolling) was set to 900° C. and hot rolled to 10 mm plates, and rapidly cooled with water to room temperature after completion of hot rolling. Next, scales on the surface were removed by facing to a thickness of 9 mm, and cold rolling was carried out to obtain plates having a thickness of 0.15 mm. Solutionizing was then carried out at respective temperature and time, and after completion of solutionizing, rapidly cooled with water to room temperature. Next, in an inert atmosphere, first aging treatment was carried out at respective temperature and time, subjected to cold rolling with respective thickness reduction, and finally, in an inert atmosphere, second aging treatment was carried out at respective temperature and time to manufacture each test strip.

TABLE 3

| | | | | | | | | | | Cold | | |
|---|---|---|---|---|---|---|---|---|---|---|---|---|
| | | | | | | | | | | Rolling | | |
| | | | | | | Solutionizing | | First Aging | | Thickness | Second Aging | |
| | Composition (% by mass) | | | | | Temperature | Time | Temperature | Time | Reduction | Temperature | Time |
| No. | Ni | Co | Si | Cr | Other | (° C.) | (s) | (° C.) | (hr) | (%) | (° C.) | (hr) |
| 51 | 1.8 | 1.0 | 0.65 | | | 1000 | 60 | 375 | 24 | 40 | 275 | 48 |
| 52 | 1.8 | 1.0 | 0.65 | | | 1000 | 60 | 450 | 9 | 40 | 275 | 48 |
| 53 | 1.8 | 1.0 | 0.65 | | | 1000 | 60 | 525 | 3 | 40 | 275 | 48 |
| 54 | 1.8 | 1.0 | 0.65 | | | 1000 | 60 | 375 | 24 | 40 | 350 | 12 |
| 55 | 1.8 | 1.0 | 0.65 | | | 1000 | 60 | 525 | 3 | 40 | 350 | 12 |
| 56 | 1.8 | 1.0 | 0.65 | | | 1000 | 60 | 375 | 24 | 40 | 450 | 3 |
| 57 | 1.8 | 1.0 | 0.65 | | | 1000 | 60 | 450 | 9 | 40 | 450 | 3 |
| 58 | 1.8 | 1.0 | 0.65 | | | 1000 | 60 | 525 | 3 | 40 | 450 | 3 |
| 59 | 1.8 | 1.0 | 0.65 | | | 1000 | 60 | 550 | 3 | 40 | 350 | 12 |
| 60 | 1.8 | 1.0 | 0.65 | | | 1000 | 60 | 480 | 48 | 40 | 350 | 48 |
| 61 | 1.8 | 1.0 | 0.65 | 0.2 | | 1000 | 60 | 375 | 24 | 40 | 275 | 48 |
| 62 | 1.8 | 1.0 | 0.65 | 0.2 | | 1000 | 60 | 450 | 9 | 40 | 275 | 48 |
| 63 | 1.8 | 1.0 | 0.65 | 0.2 | | 1000 | 60 | 525 | 3 | 40 | 275 | 48 |
| 64 | 1.8 | 1.0 | 0.65 | 0.2 | | 1000 | 60 | 375 | 24 | 40 | 350 | 12 |
| 65 | 1.8 | 1.0 | 0.65 | 0.2 | | 1000 | 60 | 525 | 3 | 40 | 350 | 12 |
| 66 | 1.8 | 1.0 | 0.65 | 0.2 | | 1000 | 60 | 375 | 24 | 40 | 450 | 3 |
| 67 | 1.8 | 1.0 | 0.65 | 0.2 | | 1000 | 60 | 450 | 9 | 40 | 450 | 3 |
| 68 | 1.8 | 1.0 | 0.65 | 0.2 | | 1000 | 60 | 525 | 3 | 40 | 450 | 3 |
| 69 | 1.8 | 1.0 | 0.65 | 0.2 | | 1000 | 60 | 550 | 3 | 40 | 350 | 12 |
| 70 | 1.8 | 1.0 | 0.65 | 0.2 | | 1000 | 60 | 480 | 48 | 40 | 350 | 48 |
| 71 | 1.8 | 1.0 | 0.65 | | 0.1 Mg | 1000 | 60 | 375 | 24 | 40 | 275 | 48 |
| 72 | 1.8 | 1.0 | 0.65 | | 0.1 Mg | 1000 | 60 | 525 | 3 | 40 | 275 | 48 |
| 73 | 1.8 | 1.0 | 0.65 | | 0.1 Mg | 1000 | 60 | 375 | 24 | 40 | 450 | 3 |
| 74 | 1.8 | 1.0 | 0.65 | | 0.1 Mg | 1000 | 60 | 525 | 3 | 40 | 450 | 3 |
| 75 | 1.8 | 1.0 | 0.65 | 0.2 | 0.1 Mg | 1000 | 60 | 375 | 24 | 40 | 275 | 48 |
| 76 | 1.8 | 1.0 | 0.65 | 0.2 | 0.1 Mg | 1000 | 60 | 525 | 3 | 40 | 275 | 48 |
| 77 | 1.8 | 1.0 | 0.65 | 0.2 | 0.1 Mg | 1000 | 60 | 375 | 24 | 40 | 450 | 3 |
| 78 | 1.8 | 1.0 | 0.65 | 0.2 | 0.1 Mg | 1000 | 60 | 525 | 3 | 40 | 450 | 3 |
| 79 | 1.8 | 1.0 | 0.65 | | | 1000 | 60 | 480 | 3 | 20 | 350 | 12 |
| 80 | 1.8 | 1.0 | 0.65 | 0.2 | | 1000 | 60 | 480 | 3 | 20 | 350 | 12 |
| 81 | 1.8 | 1.0 | 0.65 | | | 1000 | 60 | 480 | 3 | 60 | 350 | 12 |
| 82 | 1.8 | 1.0 | 0.65 | 0.2 | | 1000 | 60 | 480 | 3 | 60 | 350 | 12 |
| 83 | 1.67 | 1.06 | 0.62 | | 0.08 Mg | 950 | 60 | 525 | 3 | 25 | 400 | 3 |
| 84 | 2.32 | 1.59 | 0.78 | | 0.1 Mg | 950 | 60 | 525 | 3 | 25 | 400 | 3 |
| 85 | 1.8 | 1.0 | 0.65 | 0.2 | | 1000 | 60 | 480 | 3 | 40 | — | — |
| 86 | 1.8 | 1.0 | 0.65 | 0.2 | | 1000 | 60 | 480 | 3 | — | — | — |
| 87 | 1.8 | 1.0 | 0.65 | | | 1000 | 60 | 480 | 3 | 40 | 325 | 1 |
| 88 | 1.8 | 1.0 | 0.65 | | | 1000 | 60 | 480 | 3 | 40 | 325 | 48 |

For each test strip obtained as described, the number density of second phase particles and alloy properties were measured as with Examples of the present invention. Measurement results are shown in Table 4.

TABLE 4

| | Density of Precipitate (a = particle size; nm) | | | | | Electrical | Initial | Repeat | |
|---|---|---|---|---|---|---|---|---|---|
| | 5 ≦ a ≦ 50 | 5 ≦ a < 20 | 20 ≦ a ≦ 50 | Precipitate | Strength | Conductivity | Fatigue | Fatigue | |
| No. | (×10¹¹/mm³) | (×10¹¹/mm³) | (×10¹¹/mm³) | Ratio | YS (MPa) | EC (% IACS) | (mm) | (mm) | Bendability |
| 51 | 3.2 | 2.9 | 0.29 | 10 | 700 | 33 | 0.13 | 0.25 | 0.5 |
| 52 | 32.0 | 22.9 | 9.1 | 2.5 | 790 | 40 | 0.1 | 0.15 | 1.0 |
| 53 | 28.0 | 18.7 | 9.3 | 2 | 740 | 47 | 0.12 | 0.18 | 0.5 |
| 54 | 3.6 | 3.2 | 0.40 | 8 | 720 | 35 | 0.12 | 0.23 | 0.5 |
| 55 | 32.0 | 28.0 | 4.0 | 7 | 720 | 49 | 0.11 | 0.2 | 0.5 |
| 56 | 40.0 | 20.0 | 20.0 | 1 | 770 | 40 | 0.1 | 0.15 | 0.8 |
| 57 | 120.0 | 40.0 | 80.0 | 0.5 | 760 | 44 | 0.1 | 0.15 | 0.8 |
| 58 | 2.4 | 0.22 | 2.2 | 0.1 | 660 | 53 | 0.18 | 0.3 | 0.3 |
| 59 | 2.0 | 1.7 | 0.31 | 5.5 | 660 | 52 | 0.16 | 0.3 | 0.3 |
| 60 | 9.0 | 6.0 | 3.0 | 2 | 740 | 48 | 0.11 | 0.18 | 0.5 |
| 61 | 3.2 | 2.9 | 0.29 | 10 | 710 | 34 | 0.13 | 0.24 | 0.5 |
| 62 | 32.0 | 22.9 | 9.1 | 2.5 | 800 | 41 | 0.11 | 0.15 | 1.0 |
| 63 | 28.0 | 18.7 | 9.3 | 2 | 750 | 48 | 0.12 | 0.18 | 0.5 |
| 64 | 3.6 | 3.2 | 0.40 | 8 | 730 | 36 | 0.12 | 0.22 | 0.5 |
| 65 | 32.0 | 28.0 | 4.0 | 7 | 730 | 50 | 0.11 | 0.2 | 0.5 |
| 66 | 40.0 | 20.0 | 20.0 | 1 | 780 | 41 | 0.1 | 0.15 | 1.0 |
| 67 | 120.0 | 40.0 | 80.0 | 0.5 | 770 | 39 | 0.11 | 0.15 | 0.8 |
| 68 | 2.4 | 0.22 | 2.2 | 0.1 | 670 | 54 | 0.2 | 0.3 | 0.3 |
| 69 | 1.0 | 0.86 | 0.14 | 6 | 675 | 54 | 0.15 | 0.28 | 0.3 |
| 70 | 9.9 | 6.6 | 3.3 | 2 | 750 | 49 | 0.12 | 0.17 | 0.5 |
| 71 | 3.2 | 2.9 | 0.30 | 9.5 | 720 | 31 | 0.13 | 0.23 | 0.5 |
| 72 | 32.0 | 21.3 | 10.7 | 2 | 760 | 45 | 0.11 | 0.18 | 0.8 |
| 73 | 40.0 | 20.0 | 20.0 | 1 | 790 | 38 | 0.1 | 0.14 | 1.0 |
| 74 | 2.4 | 0.22 | 2.2 | 0.1 | 680 | 51 | 0.17 | 0.28 | 0.3 |
| 75 | 3.2 | 2.9 | 0.29 | 10 | 730 | 32 | 0.12 | 0.22 | 0.5 |
| 76 | 32.0 | 21.3 | 10.7 | 2 | 770 | 46 | 0.09 | 0.13 | 0.8 |
| 77 | 40.0 | 20.0 | 20.0 | 1 | 800 | 52 | 0.11 | 0.16 | 1.0 |
| 78 | 2.4 | 0.22 | 2.2 | 0.1 | 690 | 33 | 0.11 | 0.2 | 0.3 |
| 79 | 40.0 | 26.7 | 13.3 | 2 | 810 | 44 | 0.08 | 0.12 | 0.5 |
| 80 | 40.0 | 28.6 | 11.4 | 2.5 | 820 | 45 | 0.08 | 0.12 | 0.5 |
| 81 | 80.0 | 67.7 | 12.3 | 5.5 | 860 | 46 | 0.01 | 0.06 | 4.0 |
| 82 | 80.0 | 67.7 | 12.3 | 5.5 | 870 | 46 | 0.01 | 0.05 | 4.0 |
| 83 | 3.0 | 0.50 | 2.5 | 0.2 | 768 | 43 | 0.14 | 0.18 | 0.3 |
| 84 | 6.0 | 1.0 | 5.0 | 0.2 | 774 | 40 | 0.11 | 0.15 | 0.5 |
| 85 | 0.36 | 0.22 | 0.14 | 1.5 | 820 | 43 | 0.08 | 0.13 | 1.5 |
| 86 | 147.7 | 67.7 | 80.0 | 0.8 | 640 | 44 | 0.24 | 0.32 | 0.0 |
| 87 | 32.0 | 21.3 | 10.7 | 2 | 810 | 44 | 0.08 | 0.12 | 1.5 |
| 88 | 40.0 | 28.6 | 11.4 | 2.5 | 800 | 41 | 0.11 | 0.15 | 1.5 |

### 3. Discussion

### <No. 1 to 50>

Since the number density of second phase particles was appropriate, strength, electrical conductivity, fatigue resistance and bendability were all superior.

### <No. 51, 61, 71, 75>

The temperatures for the first and second aging were low, and second phase particles having a particle size 5-50 nm became insufficient in the whole.

### <No. 52, 62>

The temperature for the second aging was low, and the proportion of second phase particles having a particle size 5 nm to less than 20 nm became small.

### <No. 53, 63, 72, 76>

The temperature for the first aging was high while the temperature for the second aging was low, and the proportion of second phase particles having a particle size 5 nm to less than 20 nm became small.

### <No. 54, 64>

The temperature for the first aging was low, and second phase particles having a particle size 5-50 nm became insufficient in the whole.

### <No. 55, 59, 65, 69>

The number of second phase particles having a particle size 5-50 nm was small in the whole, and the balance between second phase particles having a particle size of 20-50 nm and second phase particles having a particle size 5 nm to less than 20 nm was poor.

### <No. 56, 66, 73, 77>

The temperature for the first aging was low while the temperature for the second aging was high, and the balance between second phase particles having a particle size of 20-50 nm and second phase particles having a particle size 5 nm to less than 20 nm became poor.

### <No. 57, 67>

The temperature for the second aging was high, and the proportion of second phase particles having a particle size 5 nm to less than 20 nm became small.

### <No. 58, 68, 74, 78>

The temperatures for the first and second aging were high and second phase particles were overdeveloped in the whole, and second phase particles having a particle size 5-50 nm defined in the present invention became insufficient in the whole.

### <No. 60, 70>

The time for the first and second aging were long, and second phase particles having a particle size 5 nm to less than 20 nm became insufficient.

### <No. 79, 80>

The thickness reduction of cold rolling between first and second aging and the effect of second aging was weak, and the proportion of second phase particles having a particle size 5 nm to less than 20 nm became small.

### <No. 81, 82>

Although No. 81 and 82 are Examples, the thickness reduction of cold rolling between the first and second aging was high and the effect of second aging became strong, and bendability became reduced.

### <No. 83, 84>

The temperature for the first aging was high while the thickness reduction of cold rolling between the first and second aging was low, and the proportion of second phase particles having a particle size 5 nm to less than 20 nm became small.

### <No. 85, 86>

Because second aging was omitted, the proportion of second phase particles having a particle size 5 nm to less than 20 nm became small.

### <No. 87>

Because the aging time of second aging was shorter than the first aging, the proportion of second phase particles having a particle size 5 nm to less than 20 nm became small.

### <No. 88>

Because the aging time of second aging was longer than the first aging, the proportion of second phase particles having a particle size 5 nm to less than 20 nm became small.

### DESCRIPTION OF SYMBOLS

11 Test strip
12 Knife edge
13 Gauge length
14 Vise
15 Stroke
16 Fatigue

1. A copper alloy for electronic materials containing Ni: 1.0-2.5% by mass, Co: 0.5-2.5% by mass, Si: 0.3-1.2% by mass, and the remainder comprising Cu and unavoidable impurities, wherein among second phase particles precipitated in the copper matrix of the alloy, the number density of those particles having a particle size of 5-50 nm is 1×10¹² to 1×10¹⁴/mm³, and the number density of those particles having a particle size of 5 nm to less than 20 nm is 3-6 as represented by the ratio to the number density of those particles having a particle size of 20-50 nm.

2. The copper alloy for electronic materials according to claim 1, wherein the number density of second phase particles having a particle size of 5 nm to less than 20 nm is 2×10¹² to 7×10¹³/mm³, and the number density of second phase particles having a particle size of 20-50 nm is 3×10¹¹ to 2×10¹³/mm³.

3. The copper alloy for electronic materials according to claim 1 or 2, further containing up to 0.5% by mass of Cr.

4. The copper alloy for electronic materials according to claim 1 or 2, further containing a total of up to 2.0% by mass of one or more selected from the group consisting of Mg, P, As, Sb, Be, B, Mn, Sn, Ti, Zr, Al, Fe, Zn and Ag.

5. A method for manufacturing copper alloy for electronic materials comprising the sequential steps of:
fusion casting an ingot having a desired composition;
heating the ingot at a material temperature of 950-1050° C. for 1 hour or more, and then hot rolling;
optionally cold rolling;
solutionizing by heating at a material temperature of 950-1050° C.;
first aging by heating at a material temperature of 400-500° C. for 1 to 12 hours;
cold rolling to a thickness reduction of 30-50%; and
second aging by heating at a material temperature of 300-400° C. for 3 to 36 hours, wherein the said heating time is 3 to 10-fold the first aging time.

6. A wrought copper and copper alloy product consisting of the copper alloy for electronic materials according to claim 1.

7. An electronic part containing the copper alloy for electronic materials according to claim 1.

8. The copper alloy for electronic materials according to claim 3, further containing a total of up to 2.0% by mass of one or more selected from the group consisting of Mg, P, As, Sb, Be, B, Mn, Sn, Ti, Zr, Al, Fe, Zn and Ag.

9. A wrought copper and copper alloy product consisting of the copper alloy for electronic materials according to claim 2.

10. A wrought copper and copper alloy product consisting of the copper alloy for electronic materials according to claim 3.

11. A wrought copper and copper alloy product consisting of the copper alloy for electronic materials according to claim 4.

12. An electronic part containing the copper alloy for electronic materials according to claim 2.

13. An electronic part containing the copper alloy for electronic materials according to claim 3.

14. An electronic part containing the copper alloy for electronic materials according to claim 4.
